(19) United States
(12) Patent Application Publication
(10) Pub. No.: US 2026/0212679 A1
(43) Pub. Date: Jul. 23, 2026

(54) PROCESSING DEVICE, MONITORING SYSTEM AND MONITORING METHOD

(71) Applicant: DeCloak Intelligences Co., Taipei City (TW)

(72) Inventor: Yao-Tung Tsou, Taipei City (TW)

(73) Assignee: DeCloak Intelligences Co., Taipei City (TW)

(21) Appl. No.: 19/435,760

(22) Filed: Dec. 30, 2025

Related U.S. Application Data
(60) Provisional application No. 63/740,282, filed on Dec. 30, 2024.

(30) Foreign Application Priority Data
Aug. 11, 2025 (TW) 114130504

(51) Int. Cl. G06V 20/52; G06T 7/73; G06V 10/764; G06V 40/16

(52) U.S. Cl. CPC G06V 20/52; G06T 7/73; G06V 10/764; G06V 40/172; G06T 2207/20076; G06T 2207/20081; G06T 2207/30201; G06T 2207/30232

(57) ABSTRACT

A processing device, a monitoring system and a monitoring method are provided. The monitoring system includes an image capture device and a processing device. The image capture device captures an original image. The processing device is coupled to the image capture device. The processing device is configured to perform: obtaining the original image; identifying a plurality of target images of a plurality of monitoring targets in the original image; performing de-identification processing on the plurality of target images in the original image to generate a de-identified image; and performing posture detection on a plurality of de-identified objects in the de-identified image to generate a plurality of posture detection results.

### CROSS-REFERENCE TO RELATED APPLICATION

This application claims the priority benefit of U.S. provisional application Ser. No. 63/740,282, filed on Dec. 30, 2024 and Taiwan application serial no. 114130504, filed on Aug. 11, 2025. The entirety of each of the above-mentioned patent applications is hereby incorporated by reference herein and made a part of this specification.

### BACKGROUND

### Technical Field

The disclosure relates to a processing device, a monitoring system, and a monitoring method.

### Description of Related Art

With the aging of society, the frequency of incidents such as patient falls, unauthorized intrusions into restricted areas, and medical violence within healthcare facilities is increasing. In response to these issues, the widespread adoption of surveillance cameras and advancements in image recognition technology have enabled existing monitoring systems to almost completely track the movements of monitored targets and store related image data of the monitored targets for query. However, these technologies severely infringe upon the privacy of individuals. Furthermore, in the event of an image data breach, the identity information of the people in the image data may be exposed, potentially compromising their personal safety. Therefore, an important challenge in this field is how to effectively enhance healthcare management efficiency and alleviate the workload of medical staff while simultaneously safeguarding the privacy of individuals.

### SUMMARY

A processing device, a monitoring system and a monitoring method, which may protect the privacy of a monitoring target, are provided in the disclosure.

The monitoring system of the disclosure includes an image capture device and a processing device. The image capture device captures an original image. The processing device is coupled to the image capture device. The processing device is configured to perform the following operation. The original image is obtained. Multiple target images of multiple monitoring targets are recognized in the original image. De-identification processing is performed on the target images in the original image to generate a de-identified image. Posture detection is performed on multiple de-identified objects in the de-identified image to generate multiple posture detection results.

The monitoring method of the disclosure includes the following steps. An original image is captured. Multiple target images of multiple monitoring targets are recognized in the original image. De-identification processing is performed on the target images in the original image to generate a de-identified image. Posture detection is performed on multiple de-identified objects in the de-identified image to generate multiple posture detection results.

The processing device of the disclosure includes a processor. The processor is coupled to an image capture device. The processor is configured to perform the following operation. An original image is obtained from the image capture device. Multiple target images of multiple monitoring targets are recognized in the original image. De-identification processing is performed on the target images in the original image to generate a de-identified image. Posture detection is performed on multiple de-identified objects in the de-identified image to generate multiple posture detection results.

Based on the above, the processing device, the monitoring system, and the monitoring method of the disclosure may simultaneously perform de-identification processing on multiple monitoring targets in the original image to protect the privacy of the monitoring targets in the original image. Furthermore, the processing device, the monitoring system, and the monitoring method of the disclosure may perform posture detection on multiple de-identified objects of the monitoring targets in the original image to generate multiple posture detection results.

In order to make the above-mentioned features and advantages of the disclosure comprehensible, embodiments accompanied with drawings are described in detail below.

### BRIEF DESCRIPTION OF THE DRAWINGS

FIG. 1 is a schematic diagram of a monitoring system of an embodiment of the disclosure.

FIG. 2 is a flowchart of a monitoring method of an embodiment of the disclosure.

FIG. 3 is a schematic diagram of an image processing flow of an embodiment of the disclosure.

FIG. 4 is a schematic diagram of a training process of a classification model of an embodiment of the disclosure.

FIG. 5 is a schematic diagram of an identity registration process of an embodiment of the disclosure.

FIG. 6 is a schematic diagram of a monitoring target of an embodiment of the disclosure.

FIG. 7 is a schematic diagram of area control of an embodiment of the disclosure.

### DETAILED DESCRIPTION OF DISCLOSED EMBODIMENTS

In order to make the content of the disclosure easier to understand, the following specific embodiments are illustrated as examples of the actual implementation of the disclosure. In addition, wherever possible, elements/components/steps with the same reference numerals in the drawings and embodiments represent the same or similar parts.

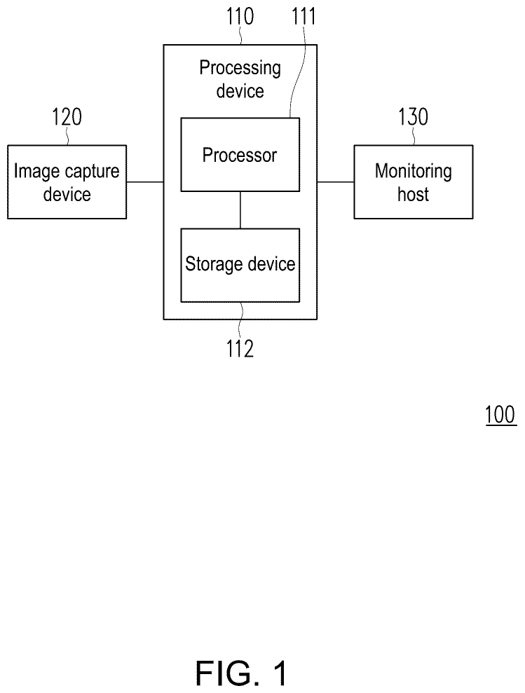

FIG. 1 is a schematic diagram of a monitoring system of an embodiment of the disclosure. Referring to FIG. 1, a monitoring system 100 includes a processing device 110, an image capture device 120, and a monitoring host 130. The processing device 110 is coupled to the image capture device 120 and the monitoring host 130. The processing device 110 may include a processor 111 and a storage device 112. In this embodiment, the monitoring system 100 may be used to implement a hospital care system, but the disclosure is not limited thereto. In this embodiment, the image capture device 120 may be, for example, disposed within a hospital or a ward, and is configured to monitor the interior of the hospital or the ward to capture an original image (original monitoring image). The processing device 110 and the monitoring host 130 may be, for example, installed in a management unit or a control console within a hospital. The processing device 110 may be implemented as a local server, but the disclosure is not limited thereto. In one embodiment, the processing device 110 may also be disposed in a cloud server.

In this embodiment, the processing device 110 may be communicatively connected to the image capture device 120 to obtain the original image from the image capture device 120. Subsequently, it performs de-identification on the original image, and then outputs the de-identified image to the monitoring host 130. In this embodiment, the monitoring host 130 may include a display. The monitoring host 130 may determine whether to generate warning information according to the de-identified image. In one embodiment, the image capture device 120 may also directly perform de-identification on the original image and then output the de-identified image to the processing device 110. Alternatively, in another embodiment, the processing device 110 and the image capture device 120 may be implemented by the same hardware device. For example, the processor 111 may be an image signal processor (ISP) of the image capture device 120, and the storage device 112 may be a memory of the image capture device 120. In addition, the storage device 112 may store a deep learning (DL) model and may be built with a feature database and an image database as described in subsequent embodiments for performing a target detection operation and de-identification processing of images. In one embodiment, the deep learning model may further include a deep neural network (DNN).

In this embodiment, the processing device 110 is, for example, a server, a workstation, or other electronic devices. The processing device 110 may include a communication device, a storage device, and a processor. The communication device, for example, supports communication protocols or application programming interfaces such as wireless fidelity, radio frequency identification, Bluetooth, infrared, near field communication or device-to-device, or supports Internet connection, for communication or network connection with the image capture device 12 or external devices. The processor 111 may be, for example, a central processing unit (CPU), or other programmable general-purpose or special-purpose microprocessor, a micro controller, a digital signal processor (DSP), a programmable controller, an application specific integrated circuit (ASIC), a programmable logic device (PLD), or other similar devices, or a combination of these devices. The storage device 112 may be, for example, any type of fixed or removable random access memory (RAM), read-only memory (ROM), flash memory, a hard drive or a similar element or a combination of the above-mentioned elements for storing a computer program executable by a processor 111. Furthermore, the storage device 112 may further store a deep learning model and related algorithms for implementing a target detection operation and a de-identification operation of images. In one embodiment, the processor 111 may load relevant computer programs, relevant algorithms, and the deep learning model from the storage device 112 to perform the monitoring method described in various embodiments of the disclosure.

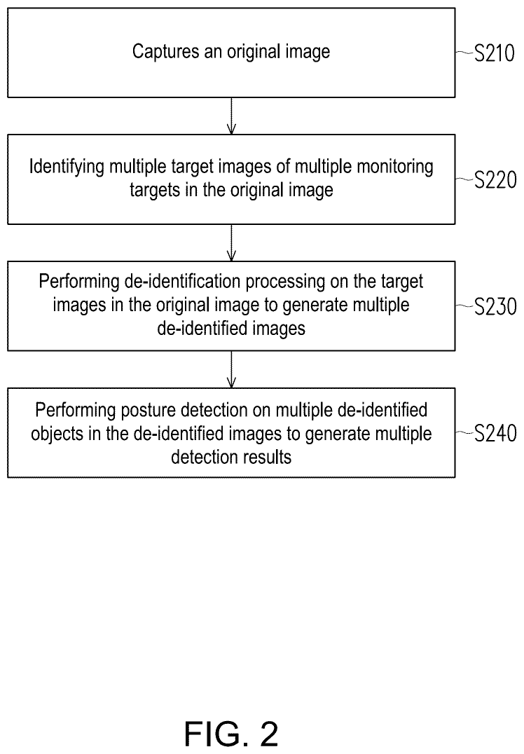

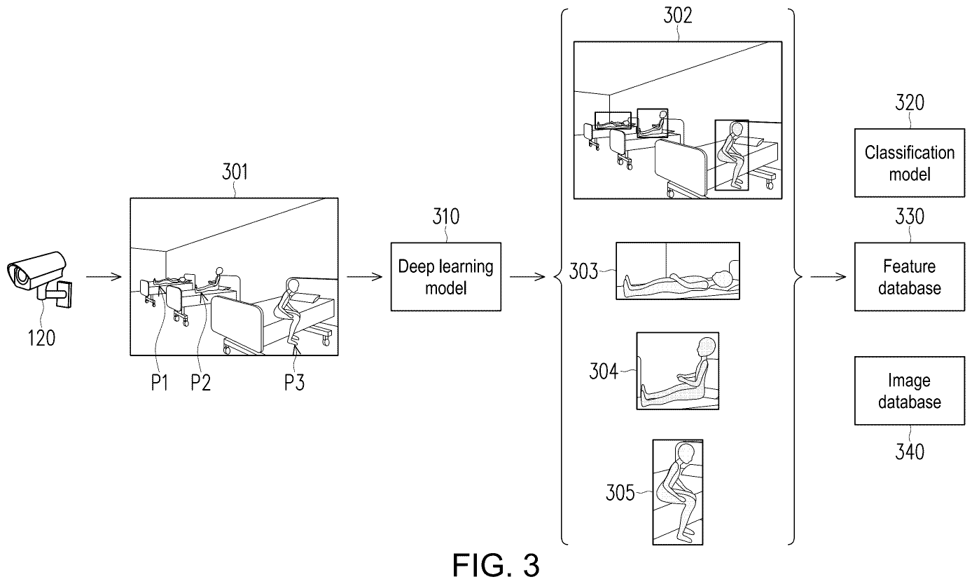

FIG. 2 is a flowchart of a monitoring method of an embodiment of the disclosure. FIG. 3 is a schematic diagram of an image processing flow of an embodiment of the disclosure. Referring to FIG. 1 and FIG. 2, the monitoring system 100 of the disclosure may perform the following steps S210 to S240. In step S210, the image capture device 120 may capture an original image. The processing device 110 may obtain the original image from the image capture device 120. In step S220, the processing device 110 may identify multiple target images of multiple monitoring targets in the original image. In step S230, the processing device 110 may perform de-identification processing on the target images in the original image to generate a de-identified image. The de-identified image may include a de-identified posture image and/or a de-identified facial image. The de-identified posture image may include the body outline features of people and the limbs outline features of people. The de-identified facial image may include a facial outline. In step S240, the processing device 110 may perform posture detection on multiple de-identified objects in the de-identified image to generate multiple posture detection results. The processing device 110 may output the de-identified image and the posture detection result to the monitoring host 130, and the monitoring host 130 may store the de-identified image as an irreversible image according to different monitoring requirements. The monitoring system 100 of this embodiment may perform de-identification protection on the full body and facial biometric features of multiple monitoring targets, thereby effectively preventing the screen from being recorded and also preventing the stored images from being misused.

Specifically, with reference to FIG. 3, the storage device 112 of FIG. 1 may further store a deep learning model 310, a classification model 320, a feature database 330, and an image database 340, but the disclosure is not limited thereto. In one embodiment, at least one of the feature database 330 and the image database 340 may also be stored in the processing device 110 or an external cloud server. In this embodiment, the image capture device 120 may capture, for example, an original image 301 of the interior of a ward. The processor 111 may utilize the deep learning model 310 pre-stored in the storage device 112 to perform de-identification processing on the original image 301. In this embodiment, the processor 111 may input the original image 301 into the deep learning model 310. The deep learning model 310 may have an object detection function, and thus may identify multiple monitoring targets P1 to P3 in the original image 301. The monitoring targets P1 to P3 may be, for example, multiple patient images. Furthermore, the deep learning model 310 may mask the monitoring targets P1 to P3 in the original image 301 to generate a de-identified image 302 having multiple de-identified objects 303 to 305.

In this embodiment, the processing device 110 may output the de-identified image 302 to the monitoring host 130, so that the de-identified image 302 may be displayed on a display of the monitoring host 130 for reference by the management personnel. Alternatively, the monitoring host 130 may further output the de-identified image 302 to other display devices, so as to display the de-identified image 302 through the other display devices. In this embodiment, since the monitoring targets P1 to P3 in the de-identified image 302 have been masked, even if the de-identified image 302 displays the outlines of the monitoring targets P1 to P3, the management personnel viewing the de-identified image 302 still cannot directly identify the identities of the monitoring targets P1 to P3. Therefore, the de-identified image 302 may effectively protect the privacy of the monitoring targets P1 to P3. It is worth noting that the de-identified image 302 does not pose any personal information risk and may be processed in real time by edge devices without being transmitted back to the processing device 110 or the cloud for storage or analysis. Therefore, the risk of data leakage and information security maintenance costs may be effectively reduced.

In this embodiment, the deep learning model 310 may extract multiple target images of the monitoring targets P1 to P3 from the original image 301. The target images may be people images or facial images respectively. The people image may include a facial image. Furthermore, the processor 111 may perform posture detection and facial recognition on the de-identified objects 303 to 305 in the de-identified image 302 to generate multiple de-identified posture features and multiple de-identified facial features. In this embodiment, the processor 111 may input the de-identified posture features into the classification model 320 respectively to generate multiple posture detection results. Furthermore, the processor 111 may respectively determine whether the de-identified facial features match multiple pre-stored facial features in the feature database 320 to generate multiple facial recognition results. In this embodiment, the de-identified objects 303 to 305 may be de-identified posture images or de-identified facial images, and the processor 111 may store the de-identified posture images or de-identified facial images in the image database 330. In other words, the monitoring system 100 of the disclosure may inherently comply with privacy protection principles and reduce regulatory risks. The monitoring system 100 of the disclosure may complete human form de-identification during the data collection stage to avoid collecting identifiable information. Therefore, the monitoring system 100 of the disclosure may comply with privacy compliance requirements such as the general data protection regulation (GDPR), the health insurance portability and accountability act (HIPAA), and the personal information protection act.

In this embodiment, the processor 111 may perform the de-identification operation based on, for example, image differential privacy and segmentation transformation algorithms, so as to generate de-identified facial features and de-identified posture features in a shorter time. Alternatively, in one embodiment, the processor 111 may perform the de-identification operation based on other encryption algorithms (e.g., homomorphic encryption algorithm).

In this embodiment, the classification model 320 may generate multiple probability values for each of the de-identified posture features. Furthermore, the processor 111 selects the one with the highest value among the probability value for each of the de-identified posture features as the corresponding posture detection result.

In this embodiment, if the de-identified facial features of a monitoring target match the pre-stored facial features (e.g., the similarity between the de-identified facial features and the pre-stored facial features is greater than a threshold value), it means that the identity of the monitoring target corresponds to a specific person. Accordingly, the processor 111 may generate a corresponding facial recognition result, and the processing device 110 may output the facial recognition result to the monitoring host 130. On the contrary, if the de-identified facial features of a monitoring target do not match any pre-stored facial features (e.g., the similarity between the de-identified facial features and the pre-stored facial features is less than or equal to a threshold value), it means that the identity of the monitoring target is unknown. In other words, the monitoring system 100 of this embodiment may protect the privacy of multiple monitoring targets while accurately identifying the multiple monitoring targets.

In addition, in order to establish the facial feature space in the feature database 320, the processing device 110 may obtain multiple historical facial images of multiple people (e.g., through the image capture device 120). The processor 111 may perform a de-identification operation on the historical facial images according to the deep learning model 310 to generate multiple historical de-identified facial features. The processor 111 may establish a corresponding facial feature space according to the historical de-identified facial features. The facial feature space may respectively include at least one historical de-identified facial feature corresponding to the identity of a specific person. The facial feature space may be obtained by, for example, an embedded space or a loss function, such as AdaFace or ArcFace, etc., which includes optimizing the margin of geodesic distance through the corresponding relationship of angles and radians in the normalized hypersphere.

On the other hand, the processor 111 may perform a de-identification operation on the target images (i.e., people images and/or facial images) of the monitoring targets P1 to P3 in the original image 301 to generate de-identified facial labels. The de-identification operation for generating the de-identified facial labels and the de-identification operation for generating the de-identified facial features may be the same or different. That is, the de-identified posture labels and the de-identified posture features may be the same or different. The de-identified facial labels and the de-identified facial features may be the same or different. In one embodiment, the processor 111 may perform a de-identification operation for generating a de-identified facial label based on, for example, a homomorphic encryption algorithm to generate a de-identified facial label that is more easily recognizable. Alternatively, the processor 111 may perform the de-identification operation based on other encryption algorithms (e.g., a differential privacy algorithm). In one embodiment, the processor 111 may perform a de-identification operation based on a homomorphic encryption algorithm based on post-quantum-secure de-identification technology.

In one embodiment, after generating the de-identified facial labels, the processing device 110 may establish or update the image database 340 by using the de-identified facial labels. Specifically, the processor 111 may establish a mapping relationship between the de-identified facial labels and the de-identified facial images. In this regard, the image database 340 may store the de-identified facial labels, the de-identified facial images, and the mapping relationship between the two.

In one embodiment, after generating the de-identified facial labels, the processing device 110 may query relevant facial image data of the monitoring target by using the de-identified facial labels. Specifically, the image database 340 may pre-store historical de-identified facial labels and historical de-identified facial images having a mapping relationship. The processing device 110 may query the image database 340 to determine whether a historical de-identified facial label matching the de-identified facial label is stored. For example, the processor 111 may perform a fuzzy search on the image database 340 according to the de-identified facial label to determine whether a historical de-identified facial label matching the de-identified facial label is stored in the image database 340. If the de-identified facial label matches the historical de-identified facial label in the image database 340 (e.g., the similarity between the de-identified facial label and the historical de-identified facial label is greater than a threshold value), the processor 111 may output the historical de-identified facial image corresponding to the historical de-identified facial label for user reference. If the de-identified facial label does not match any historical de-identified facial label in the image database 340, it means that the image database 340 does not store any facial image data related to the monitoring target.

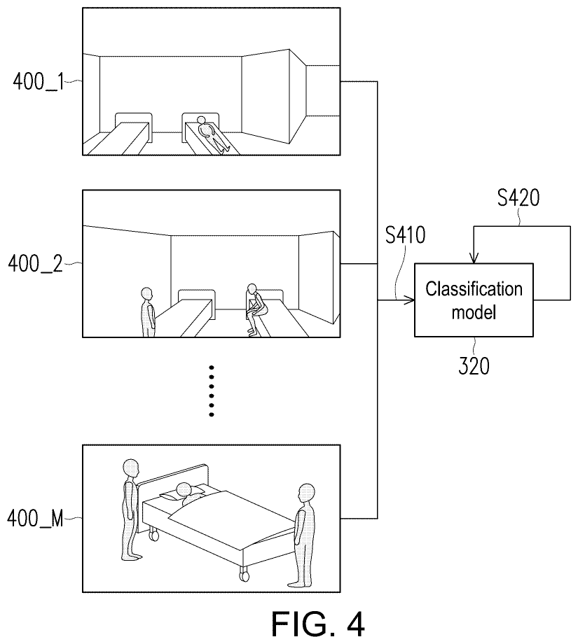

FIG. 4 is a schematic diagram of a training process of a classification model of an embodiment of the disclosure. In this embodiment, the classification model 320 may be, for example, a convolutional neural network (CNN) model, such as EfficientNet, but the disclosure is not limited thereto. Referring to FIG. 4, the classification model 320 may be trained through the process of the following steps S410 and S420. In step S410, multiple de-identified posture features of multiple training data 400_1 to 400_M may be input into the classification model 320, where M is a positive integer. The training data 400_1 to 400_M may be, for example, reference images of the interior of a hospital or a ward, and may be de-identified to generate multiple de-identified posture features. The training data 400_1 to 400_M may further include multiple labels corresponding to the de-identified posture features. The labels are configured to record the posture types corresponding to the de-identified posture features. In step S420, the classification model 320 may adjust model parameters of the classification model 320 according to the classification results of the training data 400_1 to 400_M and the labels. Therefore, the classification model 320 of this embodiment may effectively identify the posture type of the de-identified posture images in the hospital scene. The classification model 320 of this embodiment may be trained on de-identified images from the beginning and may focus on behavioral features such as limb movements and joint changes, so as to effectively improve the accuracy and stability of image recognition in different masked environments.

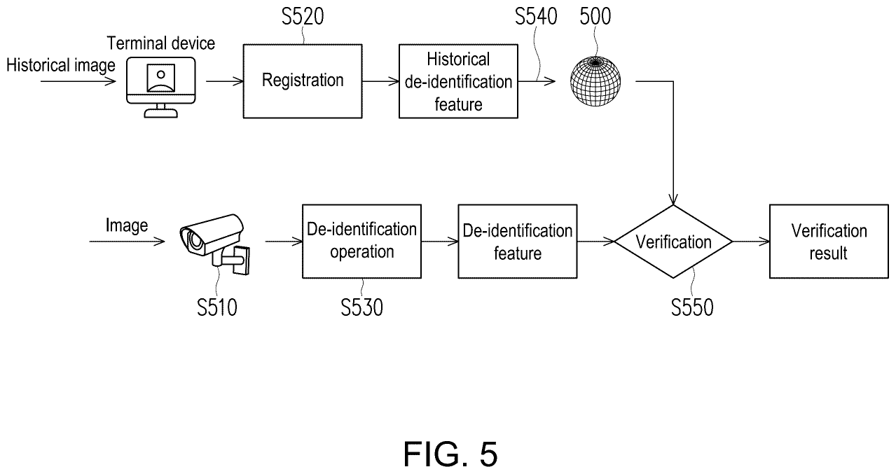

FIG. 5 is a schematic diagram of an identity registration process of an embodiment of the disclosure. Referring to FIG. 1 and FIG. 5, in this embodiment, the monitoring system 100 may perform the following steps S510 to S550 to implement a registration process to establish a feature space. Specifically, the processor 111 may be communicatively connected to an external terminal device. The data provider may transmit historical facial images for registration to the processor 111 via a terminal device, in which the historical facial images may include facial images of specific targets (e.g., people on a blacklist or members of a shopping mall). In step S520, the processor 111 may execute a registration process. The processor 111 may perform a de-identification operation (e.g., a de-identification operation based on a differential privacy algorithm) on the historical facial image to obtain at least one historical de-identified facial feature. In step S540, the processor 111 may establish a feature space 500 including at least one pre-stored facial feature according to the at least one historical de-identified facial feature.

Upon the completion of the establishment of the feature space 500, the processor 111 may perform identity verification according to the feature space 500. Specifically, in step S510, the processor 111 may obtain an image including at least one monitoring target through the image capture device 120. In step S530, the processor 111 may extract at least one facial image of at least one monitoring target from the image by using a deep learning model, and perform a de-identification operation on the at least one facial image to generate at least one de-identification feature. The de-identified feature may be a de-identified facial feature. In step S550, the processor 111 may compare the similarity between the at least one de-identified feature and a pre-stored feature (e.g., at least one pre-stored facial feature) in the feature space 60 to verify the identity of the monitored person, thereby generating a verification result.

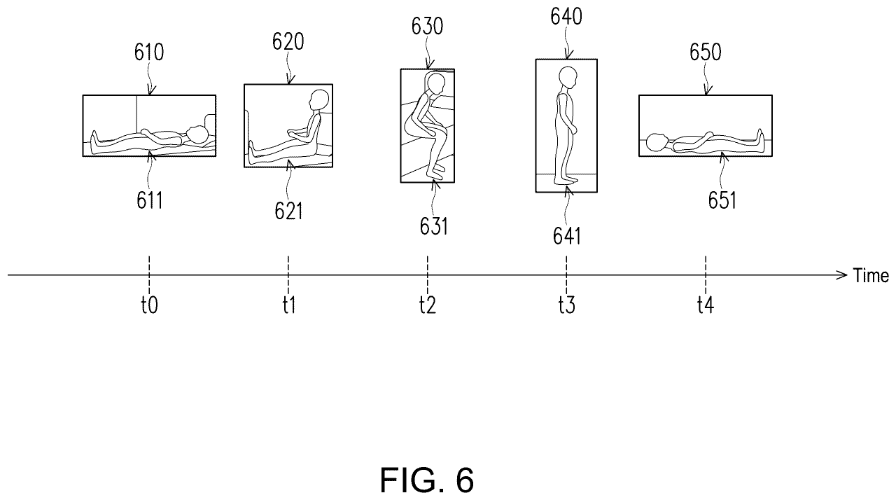

FIG. 6 is a schematic diagram of a monitoring target of an embodiment of the disclosure. Referring to FIG. 1 and FIG. 6, in this embodiment, the monitoring host 130 may obtain the de-identified image and the posture detection result from the processing device 110, and display the de-identified image via a display. In this embodiment, the monitoring host 130 may determine whether to generate warning information according to multiple posture detection results corresponding to different monitoring targets. Taking a monitoring target as an example, the processing device 110 may be pre-set to generate corresponding warning information for the posture detection results of “sitting on the edge of the bed”, “standing (getting out of bed)” and “falling (getting out of bed)”.

For example, as shown in FIG. 6, at time t0, the processing device 110 may perform the posture detection described in the above embodiment on the de-identified object 611 in the de-identified image 610 to output a corresponding posture detection result (lying flat) to the monitoring host 130. The monitoring host 130 may not generate warning information for the posture detection result corresponding to lying flat.

At time t1, the processing device 110 may perform the posture detection described in the above embodiment on the de-identified object 621 in the de-identified image 620 to output a corresponding posture detection result (sitting posture) to the monitoring host 130. The monitoring host 130 may not generate warning information for the posture detection result corresponding to the sitting posture.

At time t2, the processing device 110 may perform the posture detection described in the above embodiment on the de-identified object 631 in the de-identified image 630 to output a corresponding posture detection result (sitting on the edge of the bed) to the monitoring host 130. The monitoring host 130 may generate warning information for the posture detection result corresponding to sitting on the edge of the bed. The warning information may be the first warning information, and may be, for example, displayed as a specific pattern or mark in the de-identified image 630, or may be played as a warning audio through a speaker to notify the monitoring personnel in real time.

At time t3, the processing device 110 may perform the posture detection described in the above embodiment on the de-identified object 641 in the de-identified image 640 to output a corresponding posture detection result (standing (getting out of bed)) to the monitoring host 130. The monitoring host 130 may generate warning information for the posture detection result corresponding to standing (getting out of bed). The warning information may be the second warning information, and may be, for example, displayed as a specific pattern or mark in the de-identified image 640, or may be played as a warning audio through a speaker to notify the monitoring personnel in real time again.

At time t4, the processing device 110 may perform the posture detection described in the above embodiment on the de-identified object 651 in the de-identified image 650 to output a corresponding posture detection result (falling (getting out of bed)) to the monitoring host 130. The monitoring host 130 may generate warning information for the posture detection result corresponding to falling (getting out of bed), in which the warning information may be fall notification information. The warning information may be, for example, displayed as a prominent specific pattern or mark in the de-identified image 650, or may be played as a distinct warning audio through a speaker to inform the monitoring personnel.

Therefore, the monitoring system 100 of this embodiment may provide a warning function in real time according to the posture detection result of the de-identified image while also maintaining personal privacy. Accordingly, the monitoring system 100 of this embodiment may monitor multiple monitoring targets simultaneously, and may be set to detect multiple postures through the user interface of the backend monitoring host 130 to send warning information or abnormal alarms to relevant units in real time. The monitoring system 100 of this embodiment may be deployed in highly privacy-sensitive environments such as medical care, long-term care, and public spaces, and even under privacy masking, the monitoring system 100 may still identify risky behaviors such as falls, violence, and abnormal movements. The monitoring system 100 of this embodiment may effectively assist monitoring personnel to prevent danger from occurring, and can, for example, achieve good ward management.

In addition, in one embodiment, the storage device 112 may also store a visual language model. The processor 111 may execute a visual language model to generate text description data according to the de-identified images 610 to 650 through the visual language model. The processing device 110 may synchronously output the de-identified image and text description data to the monitoring host 130. In this way, the monitoring host 130 may synchronously display the de-identified images 610 to 650 and the corresponding text description data in sequence through the display. For example, at time t0, the monitoring host 130 may display the de-identified image 610 via a display, and display corresponding subtitles indicating that the monitoring target is currently in a lying flat posture. At time t1, the monitoring host 130 may display the de-identified image 610 via a display, and display corresponding subtitles indicating that the monitoring target is currently sitting on the edge of the bed. Accordingly, the monitoring system 100 of this embodiment may also display corresponding subtitles corresponding to the current behavior of the monitoring target in real time, so that the management personnel may quickly grasp the situation of the monitoring target.

In addition, the visual language model may also determine the interactive behaviors or events between multiple monitoring targets according to the posture detection results between multiple monitoring targets in the de-identified image to generate corresponding text description data. The monitoring host 130 may analyze the sequence and cause of the event according to the text description and conduct relevant documentation. In addition, when a specific interactive behavior or a specific event occurs, the monitoring host 130 may also generate corresponding warning information to notify the monitoring personnel.

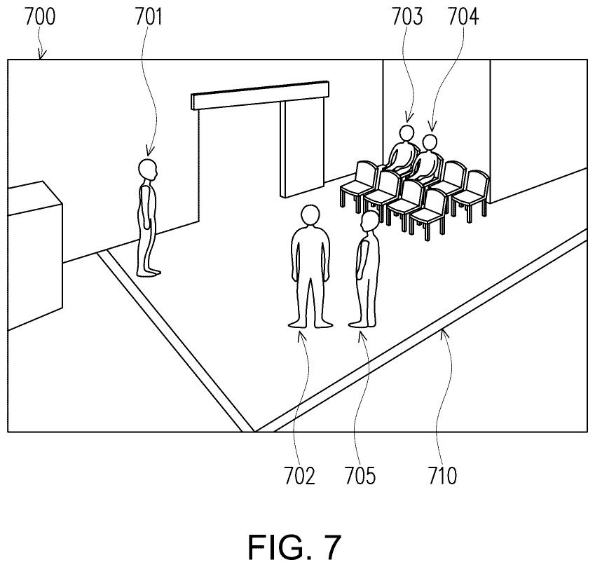

FIG. 7 is a schematic diagram of area control of an embodiment of the disclosure. Referring to FIG. 1 and FIG. 7, taking a specific area inside a hospital as an example, the processor 111 may convert the original image provided by the image capture device 120 into a de-identified image 700 as shown in FIG. 7. In this embodiment, the monitoring host 130 may obtain the de-identified image 700 and multiple facial recognition results of multiple monitoring targets from the processor 111, and display the de-identified image 700 via a display. In this embodiment, the monitoring host 130 may determine whether an unauthorized monitoring target has entered a specific area according to the facial recognition results, so as to determine whether to generate warning information.

For example, as shown in FIG. 7, the monitoring host 130 may display a de-identified image 700, and the monitoring host 130 may obtain multiple facial recognition results of multiple monitoring targets 701 to 705 from the processing device 110. The monitoring host 130 may determine whether the monitoring targets 701 to 705 enter the specific area 710 in the de-identified image 700 according to the respective positions of the monitoring targets 701 to 705 in the de-identified image 700. Next, the monitoring host 130 may determine whether at least one of the monitoring targets 701 to 705 located in the specific area 710 in the de-identified image 700 is an unauthorized monitoring target. If so, the monitoring host 130 may generate the warning information. The warning information may be, for example, displayed as a prominent specific pattern or mark on an unauthorized monitoring target in the de-identified image 700, or may be played as a distinct warning audio through a speaker to inform the monitoring personnel. Therefore, the monitoring system 100 of this embodiment may achieve an effective area control function while also maintaining personal privacy.

To sum up, the processing device, the monitoring system, and the monitoring method of the disclosure may achieve good monitoring functions while also protecting personal privacy. The processing device, the monitoring system, and the monitoring method of the disclosure may perform posture detection and/or facial recognition on de-identified images. In addition, the monitoring system of this invention may display non-identifiable images to assist users (such as the elderly, family members, or medical institutions) in accepting AI monitoring technology. This feature may enhance the acceptance and trust of users and institutions in the monitoring system.

Although the disclosure has been described in detail with reference to the above embodiments, they are not intended to limit the disclosure. Those skilled in the art should understand that it is possible to make changes and modifications without departing from the spirit and scope of the disclosure. Therefore, the protection scope of the disclosure shall be defined by the following claims.

What is claimed is:

1. A monitoring system, comprising:
an image capture device, capturing an original image; and
a processing device, coupled to the image capture device and configured to perform:
obtaining the original image;
recognizing a plurality of target images of a plurality of monitoring targets in the original image;
performing de-identification processing on the target images in the original image to generate a de-identified image; and
performing posture detection on a plurality of de-identified objects in the de-identified image to generate a plurality of posture detection results.

2. The monitoring system according to claim 1, wherein generating the de-identified image comprises:
masking the target images in the original image by using a deep learning model to generate the de-identified image.

3. The monitoring system according to claim 1, wherein the posture detection comprises:
obtaining a plurality of de-identified posture features according to the de-identified objects in the de-identified image; and
inputting the de-identified posture features into a classification model to generate the posture detection results.

4. The monitoring system according to claim 3, wherein the classification model generates a plurality of probability values for each of the de-identified posture features, and the processing device selects one with a highest value among the probability values for each of the de-identified posture features as the posture detection result.

5. The monitoring system according to claim 1, further comprising:
a monitoring host, coupled to the processing device and configured to perform:
obtaining the de-identified image from the processing device;
displaying the de-identified image; and
determining whether to generate warning information according to the posture detection results.

6. The monitoring system according to claim 5, wherein the monitoring host is further configured to perform:
generating text description data according to the de-identified image through a visual language model; and
synchronously displaying the de-identified image and the text description data.

7. The monitoring system according to claim 5, wherein the processing device is further configured to perform:
performing facial recognition on the de-identified objects in the de-identified image to generate a plurality of facial recognition results.

8. The monitoring system according to claim 7, wherein the facial recognition comprises:
performing the facial recognition on the de-identified objects in the de-identified image to generate a plurality of de-identified facial features; and
determining whether the de-identified facial features respectively match a plurality of pre-stored facial features in a feature database to generate the facial recognition results.

9. The monitoring system according to claim 7, wherein the monitoring host is further configured to perform:
determining whether an unauthorized monitoring target has entered a specific area according to the face recognition results, so as to determine whether to generate another warning information.

10. A monitoring method, comprising:
capturing an original image;
recognizing a plurality of target images of a plurality of monitoring targets in the original image;
performing de-identification processing on the target images in the original image to generate a de-identified image; and
performing posture detection on a plurality of de-identified objects in the de-identified image to generate a plurality of posture detection results.

11. The monitoring method according to claim 10, wherein generating the de-identified image comprises:
masking the target images in the original image by using a deep learning model to generate the de-identified image.

12. The monitoring method according to claim 10, wherein generating the posture detection results comprises:
obtaining a plurality of de-identified posture features according to the de-identified objects in the de-identified image; and
inputting the de-identified posture features into a classification model to generate the posture detection results.

13. The monitoring method according to claim 12, wherein generating the posture detection results comprises:
generating a plurality of probability values for each of the de-identified posture features through the classification model; and
selecting one with a highest probability value among the probability values for each of the de-identified posture features as the posture detection result.

14. The monitoring method according to claim 10, further comprising:
obtaining the de-identified image from the processing device through a monitoring host;
displaying the de-identified image through the monitoring host; and
determining whether to generate warning information according to the posture detection results through the monitoring host.

15. The monitoring method according to claim 14, further comprising:
generating text description data according to the de-identified image based on a visual language model through the monitoring host; and
synchronously displaying the de-identified image and the text description data through the monitoring host.

16. The monitoring method according to claim 14, further comprising:
performing facial recognition on the de-identified objects in the de-identified image to generate a plurality of facial recognition results.

17. The monitoring method according to claim 16, wherein generating the facial recognition results comprises:
performing the facial recognition on the de-identified objects in the de-identified image to generate a plurality of de-identified facial features; and
determining whether the de-identified facial features respectively match a plurality of pre-stored facial features in a feature database to generate the facial recognition results.

18. The monitoring method according to claim 16, further comprising:
determining whether an unauthorized monitoring target has entered a specific area according to the face recognition results through the monitoring host, so as to determine whether to generate another warning information.

19. A processing device, comprising:
a processor, coupled to an image capture device and configured to perform:
obtaining an original image from the image capture device;
recognizing a plurality of target images of a plurality of monitoring targets in the original image;
performing de-identification processing on the target images in the original image to generate a de-identified image; and
performing posture detection on a plurality of de-identified objects in the de-identified image to generate a plurality of posture detection results.

20. The processing device according to claim 19, wherein the processor is configured to obtain a plurality of de-identified posture features according to the de-identified objects in the de-identified image, and the processor is further configured to input the de-identified posture features into a classification model to generate the posture detection results.
